(19) United States
(12) Patent Application Publication
(10) Pub. No.: US 2004/0024698 A1
(43) Pub. Date: Feb. 5, 2004

(54) Method of facilitating charitable contributions using a credit card

(76) Inventors: William Hines, South Bend, IN (US); Charles Day, South Bend, IN (US)

Correspondence Address: WELSH & KATZ, LTD, 120 S RIVERSIDE PLAZA, 22ND FLOOR, CHICAGO, IL, 60606, US

(21) Appl. No.: 10/211,693

(22) Filed: Aug. 2, 2002

(51) Int. Cl. G06F 17/60

(52) U.S. Cl. 705/39

(57) ABSTRACT

A method and apparatus are provided for channeling funds to a plurality of eleemosynary organizations. The method includes the steps of receiving a payment request by an issuer of a credit card from a merchant based upon use of the credit card where the credit card contains a blind identifier of an eleemosynary organization of the plurality of eleemosynary organizations, transferring a predetermined payment from the issuer to a trust organization along with the blind identifier of the eleemosynary organization, retrieving a name of the eleemosynary organization by the trust organization based upon the transferred blind identifier and transferring the predetermined payment from the trust organization to the eleemosynary organization based upon the retrieved name of the eleemosynary organization.

### FIELD OF THE INVENTION

The field of the invention relates to charitable contributions and more particularly to charitable contributions made in conjunction with credit card use.

### BACKGROUND OF THE INVENTION

Methods of making charitable donations using credit cards are generally known. Contributions under this format may be based upon any of a number of different criteria. For example, by prior agreement, a portion of the fees that a credit card issuer normally collects from a merchant may be contributed to a charity designated by the card holder. Alternately, a percentage of a credit card user's purchases may be contributed to the designated charity.

To facilitate contributions under this format, an identifier of the charitable organization may be encoded onto the magnetic strip of the credit card. When the credit card user makes a purchase, a merchant card reader reads the credit card number and identifier of the charitable organization. The merchant enters a purchase value and a modem within the card reader dials a telephone number of the issuer. Once a connection is made, the modem transfers an identifier of the merchant, the credit card number and identification of the charity to the credit card issuer along with an amount of the purchase.

The credit card issuer verifies the credit card number, compares the purchase amount with any credit limits and issues an authorization number. The credit card issuer may also store the identifier of the charitable organization.

Periodically, the card issuer may calculate an amount to be paid to the charity. Once the amount is calculated, the credit card issuer may transfer the total directly to the charity.

While such methods work relatively well, the opportunity for abuse is rampant. For example, credit card issuers generally have very little interest in demonstrating that they have contributed the agreed-upon amount to the charity. Further, because of the nature of contributions, the charitable organization has little leverage in demanding an accounting of funds.

In addition, most charities find any association with credit card companies distasteful. Because charitable organizations operate under a different environment and mindset, they are ill-equipped and unwilling to deal with aggressive promotional campaigns by credit card companies, especially where the campaign involves the use the charity's name.

While charities and credit card companies are often at odds as to purpose, a charity could benefit from credit card donations if some method could be found to avoid conflict. Accordingly, a need exists for a method of facilitating credit card contributions to charity that avoids the commercial exploitation of the charity.

### SUMMARY

A method and apparatus are provided for channeling funds to a plurality of eleemosynary organizations. The method includes the steps of receiving a payment request by an issuer of a credit card from a merchant based upon use of the credit card where the credit card contains a blind identifier of an eleemosynary organization of the plurality of eleemosynary organizations, transferring a predetermined payment from the issuer to a trust organization along with the blind identifier of the eleemosynary organization, retrieving a name of the eleemosynary organization by the trust organization based upon the transferred blind identifier and transferring the predetermined payment from the trust organization to the eleemosynary organization based upon the retrieved name of the eleemosynary organization.

### BRIEF DESCRIPTION OF THE DRAWINGS

FIG. 1 depicts a channeling system for channeling funds to an eleemosynary organization in a context of use;

FIG. 2 depicts a flow chart of process steps that may be used by a partner credit card bank of FIG. 1;

FIG. 3 depicts a flow chart of credit card approval steps that may be used by a partner credit card bank of FIG. 1; and

FIG. 4 depicts an auditing process that may be used by the system of FIG. 1.

### DETAILED DESCRIPTION OF AN ILLUSTRATED EMBODIMENT

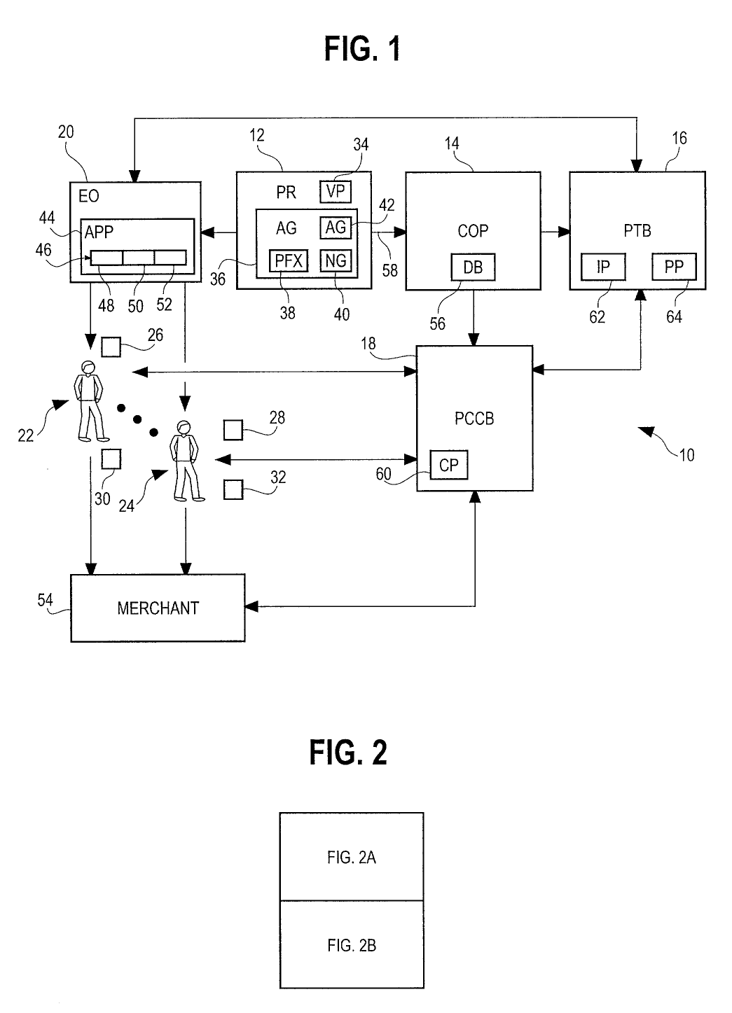

FIG. 1 depicts a channeling system 10 for channeling funds to an eleemosynary organization (e.g., a charity, faith-based organization, non-profit organization, etc.). The channeling system 10 in FIG. 1 is depicted in a context of use under an illustrated embodiment of the invention.

The channeling system 10 may generally include a presentation resource (PR) 12 and a channeling organization processor (COP) 14. The channeling system 10 may, in turn, be operated by a channeling organization. As used herein, a channeling organization means an entity that organizes the structure of the system 10 for the channeling of funds to the eleemosynary organization, but which is not a bank or a credit card issuer. The channeling organization and/or channeling system 10 may sometimes be referred to herein and in the attached drawings by the acronym “BG”.

The channeling system 10 may, in turn, be coupled to, and interact with, a partner trust bank (PTB) 16 and a partner credit card bank (PCCB) 18. While only a single PTB 16 and PCCB 18 are shown in FIG. 1, it should be understood that the system 10 may channel funds through any of a number of PTBs 16 and PCCBs 18.

The channeling system 10 may also service any of a number of eleemosynary organizations (EOs) 20. Each EO 20, in turn, would be understood to include any of a number of supporters and members 22, 24. While FIG. 1 shows only a single EO 20 and a single group of members 22, 24, it should be understood that any number of EOs 20 may be serviced by the channeling system 10, each with its own respective group of members 22, 24.

Under the illustrated embodiment, the channeling organization may use the apparatus 10 to channel funds generated by credit card use to a designated EO 20. Further, the source of the funds may be the credit card issuer (e.g., the PCCB 18) and, possibly, the EO's members 22, 24.

In order to avoid commercial exploitation of the EOs 20, by the PCCBs 18, the channeling organization maintains strict secrecy regarding the name of the EOs 20. Coded numbers are used during credit card transactions to identify the designated EO 20. The PTB 16 functions to shield the name of the EO 20 from the PCCBs 18. In general, the system 10 is structured such that the PCCBs 18 cannot learn the name of the EO 20.

As used herein, a distinction is made between the name and an identifier of the EO 20. As used herein, a name of an eleemosynary organization means a publicly known name of the eleemosynary organization or a number of a bank account of the eleemosynary organization. In contrast, an identifier or blind identifier of the EO 20 refers to a randomly generated alpha-numeric sequence that has been generated by the channeling organization and has name significance only to the channeling organization and PTB.

Turning now to the channeling apparatus 10, an explanation will first be provided as to the process of generation of credit card accounts. Following the explanation of the credit card accounts, an explanation will be provided of how credit card use may result in fund transfers to an EO 20.

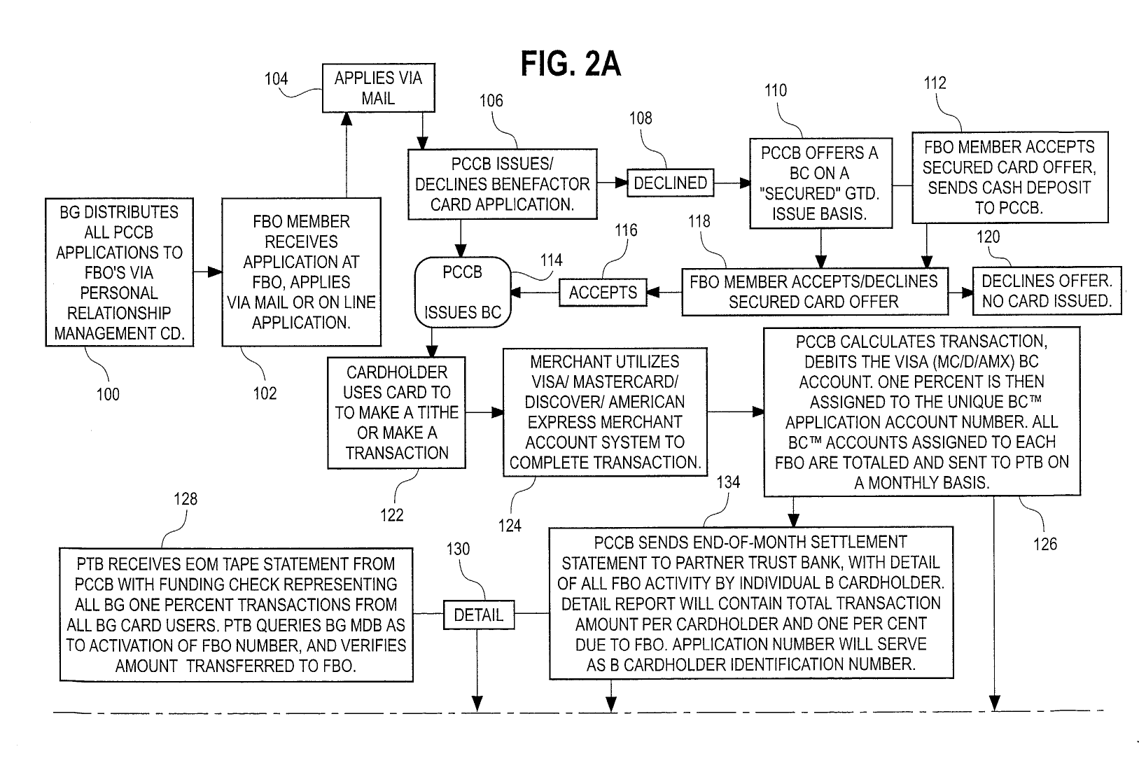

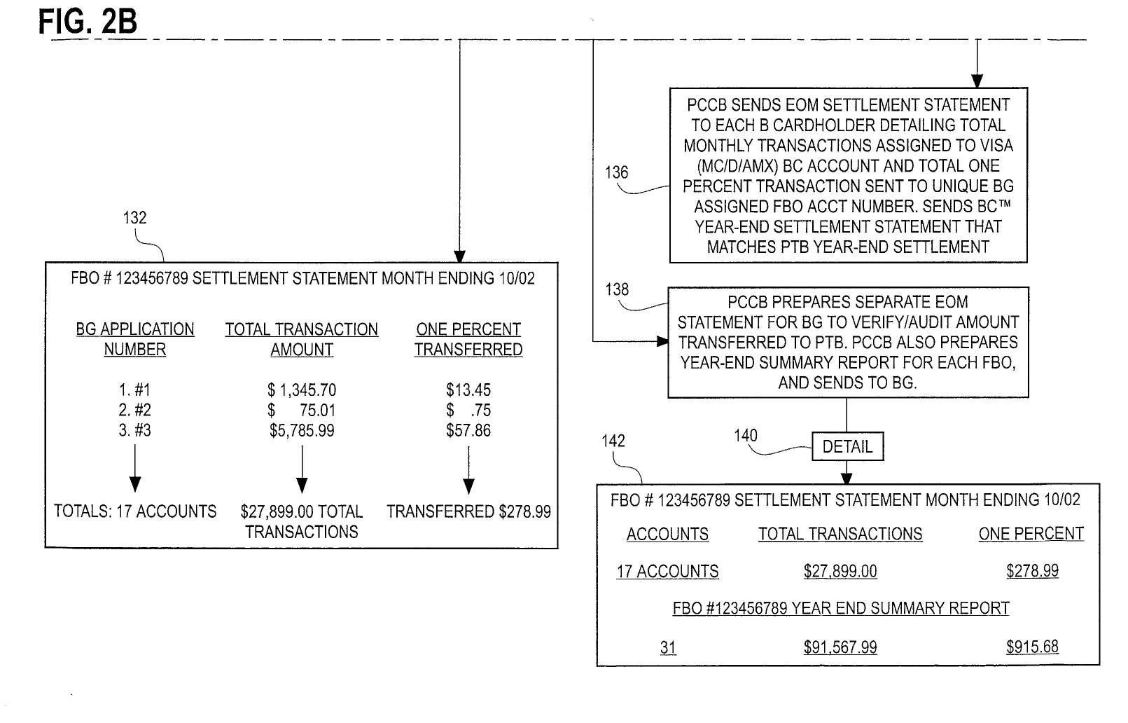

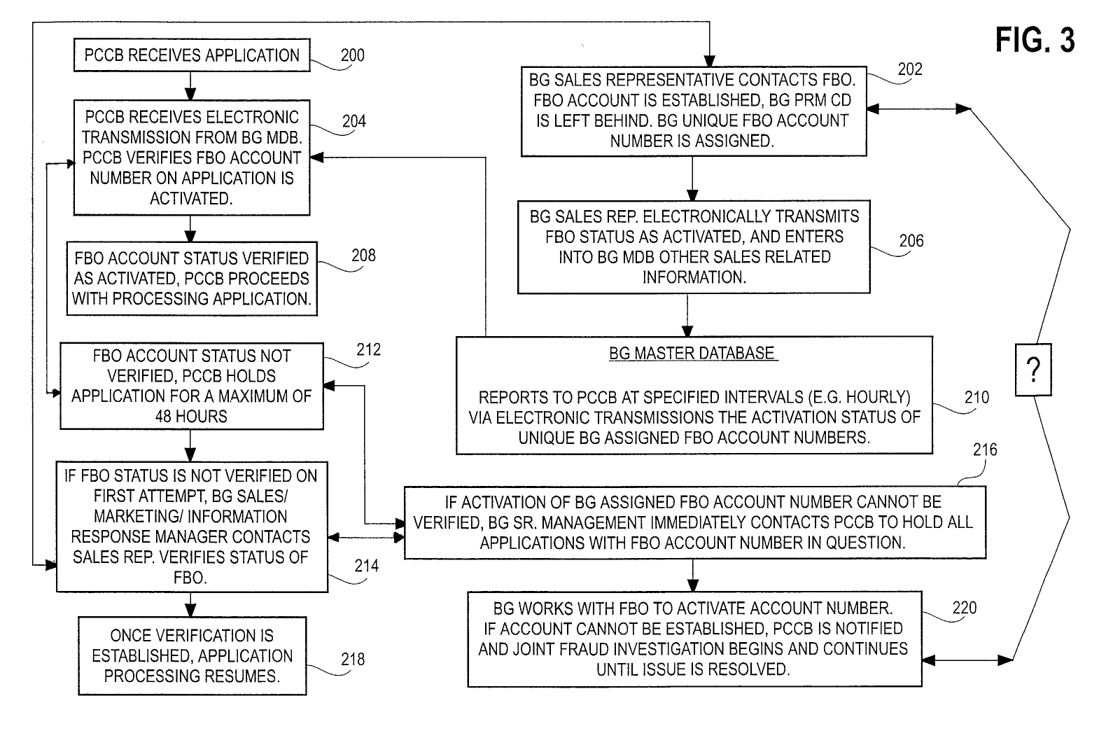

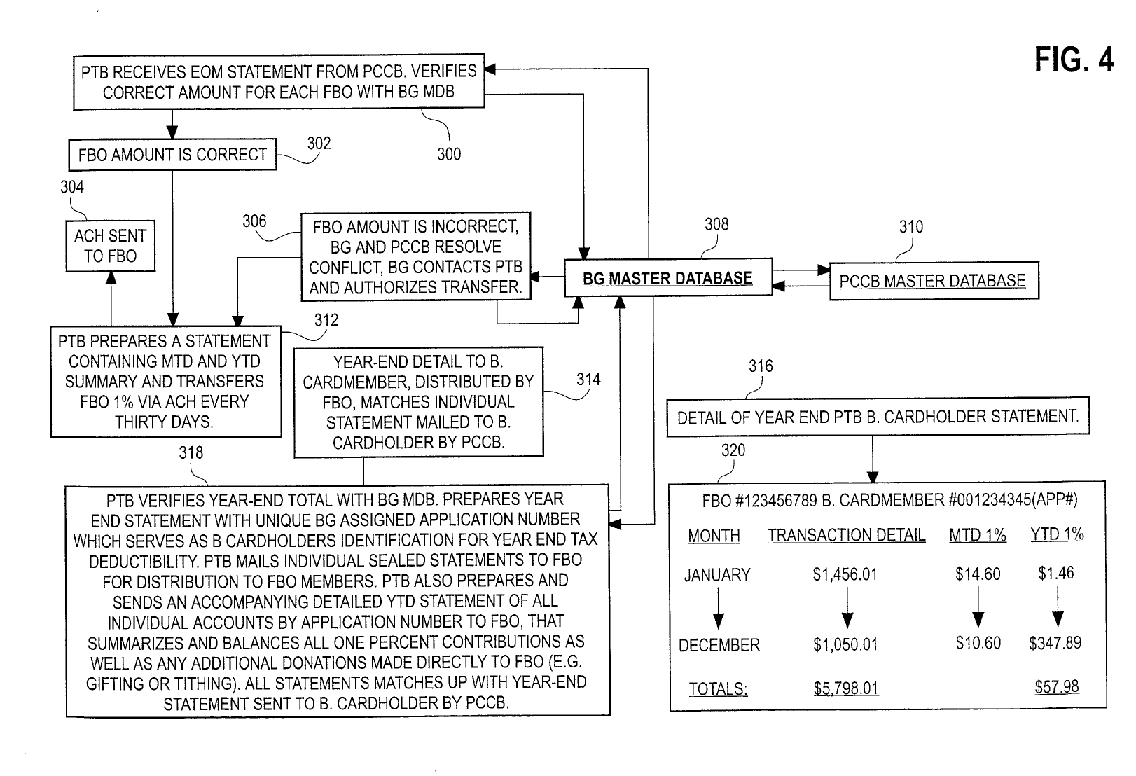

FIGS. 2 and 3 are flow charts of processes occurring within the system 10. Reference shall be made to FIGS. 2 and 3 as appropriate to an understanding of the invention.

In order to facilitate the set-up of accounts with an EO 20, a presentation resource (PR) 12 may be provided. The PR 12 may be a portable laptop computer or some other presentation mechanism (e.g., a processor) that may be used to generate an audio/visual presentation 34 extolling the funding benefits and features of the channeling system 10.

Included within the PR 12 or loaded into the PR 12 from a compact disk (CD) may be an application generator 36 that generates credit card account applications 44 for the benefit of the EOs 20. The EOs 20, in turn, may distribute the applications 44 to their members 22, 24.

Contained within the application generator 36 may be features that provide an application number 46 identifying the applications 44 as originating from the channeling system 10 and also from an individual EO 20. For example, each application number 46 may include a prefix 48 retrieved from a file 38 within the application generator 36 and that identifies the application as originating from within the system 10 or the PCCB may attach a unique application number once the application is completed and approved at the PCCB. Should the PCCB attach a unique application number, this information will be transmitted to the BG master database. IN this scenario, the association of the PCCB unique application number, and the unique BG assigned FBO number shall serve as the blind identifer.

A second portion of the application number 46 may provide an identifier 50 of the individual EO 20. A first random number generator 40 may be used to generate the identifier 50 for each particular EO 20. Since the identifier of the EO 20 is generated through a random process, the identifier could properly be referred to as a blind identifier 50.

A third portion of the application number 46 may include an identifier 52 of the individual application. A number generator 42 may be used to number the individual applications.

As such, each credit card application provided by the generator 36 would include a unique identification number 46. To summarize, a first portion of the number may identify the application as originating from within the channeling system 10. A second portion may uniquely identify the EO 20 from among other EOs. A third portion may simply be an application number or may be another randomly generated number that may later be used in identification of the user. Once the applications have been generated, the PR 12 may function to report the application numbers 46 to a database 56 within the COP 14.

In general, a sales representative of the channeling organization that operates the channeling system 10 may contact 202 the EO 20 and establish an account with the EO 20. Establishing an account with the EO 20 means creating a file within the database 56 that includes at least the name and address (or wire transfer destination number) of the EO 20. The sales representative may carry the PR 12 (or CD) to a site of the EO 20 and make a sales presentation. Following the sales presentation, the sales representative (or members of the EO 20) may activate the application generator 36 and generate a series of applications sufficient for the EO 20.

The application numbers 46 may be saved inside the PR 12 or may be immediately transferred 206 back to a database (shown as 56 in FIG. 1 and 210 in FIG. 2) and stored within the file established for the EO 20. The PR 12 may be carried back to the site of the COP 14 after the presentation, or may be connected to the COP 14 through a telephone line 58 for uploading the activated EO account number and application numbers 46 to the database 56.

The COP 14 may add the application numbers 46 to the file created for the EO account. The COP 14 may also transfer the identifier 50 of the EO 20 and application numbers to the PCCB 18.

Once the application numbers 46 have been generated, the PR 12 may be connected to a printer (not shown) and the applications may be printed. Alternatively, the application numbers and format of the applications may be saved to the CD under a pdf format. The EO 20 may then simply place the CD into a local terminal and printer and print out the applications as needed by its members 22, 24.

Once printed, the EO 20 may distribute 102 the applications to its members and supporters 22, 24. Upon receiving the numbered applications, the supporters 22, 24 of the EO 20 may independently fill out the applications with their own personal credit information. Once the applications are completed, they may be transferred (e.g., mailed 104) to the PCCB 18.

Upon receipt 200 of the credit card application, the PCCB 18 may authenticate the application and then apply its own internal standards to determine the creditworthyness of each applicant 22, 24. Authentication at a first level may mean parsing the first portion 48 from the account number 46 and identifying the system 10. If the first portion 48 is an identifier of the system 10, then the PCCB 18 may search its own records for a match between the identifier 50 of the EO 20 sponsoring the application and an identifier 50 of any records received from the COP 14. If a record match is found, then the PCCB 18 verifies that the third portion 52 is one of the numbers or within the range of numbers specified by the transferred file. If no record matches can be found with the identifier 50, the PCCB 18 may transmit an account number verification request to the COP 14.

In response, a processor within the COP 14 searches its records to verify that the second portion 50 (the blind identifier of the EO 20) has been entered into and activated 204 within its database 56. Activation may simply mean that the matching identifier found within the database is associated with an EO 20 and has an appropriate set of application numbers (the third portion 52) associated with the number. The processor may also verify that the third portion 52 is within the range allocated to the EO 20.

If the account number 46 cannot be authenticated or has not been activated, then the PCCB 18 may hold 212 the application for a predetermined time period (e.g., 48 hours). After the time period, another attempt may be made to verify activation of the application.

In addition, if the account number 46 cannot be authenticated, then the sales representative servicing the EO 20 may be contacted to verify the status 214 of the EO 20. If the account number 46 can be verified, then processing 218 of the application continues.

If the activation of the account number 46 of the EO 20 cannot be verified, then the PCCB 18 may be contacted 216 to hold all applications with the same identifier 50 and a fraud investigation 220 may be initiated.

Based upon the internal standards of the PCCB 18, the application may either be accepted or declined 106. If the application is accepted, the PCCB 18 may issue a credit bank card (BC) 30, 32.

If the application does not meet the criteria of the PCCB 18, then the application may be denied 108. IF the application is denied, then the PCCB 18 may offer the BC 110 on a secured basis.

If offered on a secured basis, the PCCB 18 may request a cash deposit 112 from the member 22, 24. The member 22, 24 may either accept the offer or decline 118, in which case no card is issued 120. If the member 22, 24 accepts 116, a BC 30, 32 issues 114 and is sent to the member 22, 24.

As part of preparation of the application 46, the applicant 22, 24 may enter a contribution level to be directed to the EO 20 by entry of instructions or by checking an appropriate selection box. A minimum (i.e., a basic) contribution may be provided by the credit card issuer 18 to the EO 20 in the form of a rebate of a portion of the fees collected by the PCCB 18 from a merchant 54 (e.g., 1%) of the transaction. The rebated portion received by the PCCB 18 may, in turn, be passed to the EO 20 as discussed below.

Alternatively, the member 22, 24 may specify an additional payment to the EO 20. The additional payment may be a flat rate (e.g., $50/mo, $500/mo, etc.) or a percentage of the member's credit card purchases (e.g., 5%). The basic contribution and entered instructions may together form a contribution file.

The PCCB 18 may issue the BC 30, 32 with a unique credit card number. The credit card number may include the application number 46, that may or may not be generated by the PCCB, either alone or along with an identifier of the PCCB 18. Should the application number be generated by the PCCB, this information will then be transferred by the PCCB to the BG master database via a predetermined file transfer protocol (FTP) or other timely reporting method. Alternatively, the PCCB 18 may generate its own unique credit card number. In the case where the PCCB 18 generates its own unique credit card number, the generated number would lead to a file within a database of the PCCB 18 containing the identifier 50 of the EO 20. In either case, the credit card number on the BC 30, 32 functions as a blind identifier of the EO 20, because of the inability of the PCCB 18 to directly identify the receiving EO 20.

The BC 30, 32 may be a conventional credit card (e.g., with the application number 46 encoded in a magnetic strip) or a smart card. Where the BC 30, 32 is a smart card, the smart card 30, 32 may be provided with a microprocessor and embedded firmware (e.g., JAVA language) for generating a variable code sequence (including the coded credit card number) when interrogated by a card reader. The variable code sequence may be used to provide additional credit card security using conventional methods.

Periodically, the member 22, 24 may use the card 30, 32 to make a transaction 122 with a merchant 54. The transaction may be processed by the merchant 54 in a conventional manner. The transaction may be cleared through the established credit card system following conventional merchant payment systems and procedures provided for the credit card (e.g., VISA, MASTERCARD, DISCOVER, AMERICAN EXPRESS, etc.). The clearing house may deduct the merchant exchange fee (MEF) and pay the merchant the remaining balance of the charged amount. The PCCB will then bill the BC holder's account for the full transaction amount.

Upon receipt of the bill from the conventional merchant payment system, the PCCB 18 accounts 126 for the transaction. As used herein, accounting for the transaction may mean calculating within a contributions processor 60 an amount due to the EO 20 and an amount to be billed to the cardholder 22, 24. Calculation of the amount due to the EO 20 may mean retrieving a contribution file of the member 22, 24 to identify any optional contributions and adding those contributions to the basic contribution. Accounting for the transaction may also mean transferring a transaction summary of each transaction to the COP 14. Accounting may also mean totaling the contributions due to each EO from its members 22, 24 and transferring a value of the total to the PTB 16 and database 56 of the COP 14 along with the blind identifier of the EO 20.

The PCCB 18 may send 136 an end-of-month (EOM) statement to each cardholder 22, 24 detailing the purchases made during the month and also the contributions. The detail of the contributions may include the basic contribution made by the card issuer 18 for the period and any optional contributions made by the cardholder 22, 24.

In addition, the PCCB 18 may also send 134 an EOM settlement statement to the PTB 16. The statement may include the details of the contributions from each of the individual members 22, 24 for each EO 20. The statement may include the amount attributable to each member due to the basis contribution as well as the total value of any optional contributions.

The PCCB 18 also prepares 138 and transfers a separate EOM statement to the COP 14. The EOM statement to the COP 14 may provide detail 140 on any of a number of levels and depth. At one level 142, the statement to the COP 14 may include summary information including the identifier of the EO 20, the number of accounts, the total transactions, basic contributions and total revenue.

The COP 14 may compare the transaction summaries with the content of its own database to verify the totals to be transferred to the EOs 20. In this regard, the COP 14 may query 300 the database 56 as part of an audit function to verify the contents of the statement against its own records. For example, one auditing function may be to verify that the contribution instructions of each member 22, 24 has been followed. Another function may be to verify that the contributions are accurate based upon the total credit card purchases of each member 22, 24. Another auditing function may be to ensure that the reported contributors is equal to the total number of members 22, 24 of the EO 20 even though some members 22, 24 did not use their BC 30, 32 during the contribution period. Another function may be whether the BC holder paid their PCCB statement on time. Not paying the statement on time, at the discretion of the PCCB may result in the transferring, or not transferring, of the BC holder contribution amount to the PTB.

The PTB 16 receives 128 the end-of-the-month statement from the PCCB 18 along with a funding check representing all contributions from the members 22, 24. The detail 130 may be provided with sufficient granularity to provide total as well as individual contributions 132.

If the statement received by the PTB 16 from the PCCB 18 is correct 302 (as verified by a query to the COP 14), then the PTB 18 prepares a statement 312 containing the month-to-day (MTD) and year-to-day (YTD) summaries of funds to the EO 20. The PTB 18 also transfers 304 the funds to the EO 20.

In order to transfer funds to the EO 20, an identity processor 62 within the PTB 18 may retrieve the name of the EO 20 from the database 56 of the COP 14 using the blind identifier contained within the statement from the PCCB 18 as a search term. Using the name of the EO 20, a payment processor 64 within the PTB 18 may complete the funds transfer by issuing a check in the name of the EO 20 and sending the check to the address of the EO 20 or by performing a wire transfer into an predetermined account of the EO 20.

If the statement from the PCCB 18 has any discrepancies, a detailed report of the known cause of the discrepancy (e.g., BC holder not paying his statement on time) will accompany the statement. If the cause of the discrepancy is not known, then an auditing application of the COP 14 may be activated. The auditing application may contact and retrieve transaction information utilizing only the BC holder's blind identifier account number, and not the PCCB unique credit card account number from a PCCB database 310 to resolve any differences. Resolution of errors may include performing an item-by-item comparison of transaction entries among the PCCB 18, the PTB 16 and the COP 14. Resolution of differences may also include contacting the cardholder 22, 24 to verify card activity by the PCCB, and then reporting results of findings in a timely manner to the COP and the PTB.

The PTB 16 may also prepare 316 YTD and end-of-year (EOY) statements for the individual members 22, 24. The YTD statement may be divided by month, card activity, month to date basic contributions and YTD contributions.

In another illustrated embodiment of the invention, the channeling of funds to an EO 20 may also be extended to the use of a bank ATM debit card. The bank ATM debit card system may be installed on a home or business computing system that has access to the Internet and may utilize various methods of completing a transaction. One method may be a system that would be installed on a home or business computing system that would have a device that would allow the card to be “swiped” and a reader would capture the information contained in the magnetic strip, and transmit the necessary information to complete the transaction via the Internet. Another method may transmit the needed information via the Internet through the use of a computing keyboard or combination thereof. One such proposed system may include the eCashCard by eConnect. An eBank would issue the eCashCards using a process similar to that discussed above for the PCCB 18. An applicant for the eCashCard would select a contribution level as part of the application process to the eBank. Purchases from Bank Eyes Only websites would result in cash transfers to the merchant as discussed above and also in contributions to the EO 20, also as discussed above. Another method may include the acceptance of a bank ATM debit card at a merchant level such as a “VISA or MASTERCARD check-card” or future acceptance of any non-VISA or MASTERCARD bank ATM debit card to be used via the Internet or accepted at a merchant level.

Under another illustrated embodiment of the invention, vendors and manufacturers may participate by matching the contribution of the PCCB 18. In this case, the merchant 54 may accept a higher merchant exchange fee for the right to advertise their support for charitable organizations in general. Manufacturers may provide rebates to merchants for selling their goods in an effort to offset the matching contribution and to also participate in the effort.

A specific embodiment of a method and apparatus for facilitating charitable contributions using a credit card according to the present invention has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of channeling funds to a plurality of eleemosynary organizations, such method comprising the steps of:
receiving a payment request by an issuer of a credit card from a merchant based upon use of the credit card where the credit card contains a blind identifier of an eleemosynary organization of the plurality of eleemosynary organizations;
transferring a predetermined payment from the issuer to a trust organization along with the blind identifier of the eleemosynary organization;
retrieving a name of the eleemosynary organization by the trust organization based upon the transferred blind identifier; and
transferring the predetermined payment from the trust organization to the eleemosynary organization based upon the retrieved name of the eleemosynary organization.

2. The method of channeling funds as in claim 1 further comprising generating a plurality of credit card applications where each credit card application of the plurality of credit card applications includes the blind identifier of at least one of the plurality of eleemosynary organizations.

3. The method of channeling funds as in claim 2 wherein the step of generating the plurality of credit card applications further comprises activating an application generation application provided by a channeling organization for the benefit of the eleemosynary organization.

4. The method of channeling funds as in claim 3 wherein the step of activating the application generation application provided by a channeling organization further comprises generating the blind identifier for use on the credit card applications.

5. The method of channeling funds as in claim 4 further comprises transferring a name of the eleemosynary organization and generated blind identifier to the trust organization.

6. The method of channeling funds as in claim 2 further comprising distributing the generated credit card applications to members or supporters of the at least one of the plurality of eleemosynary organizations.

7. The method of channeling funds as in claim 1 further comprising calculating the predetermined payment based upon a predetermined percentage of a monetary value of the payment to the merchant.

8. The method of channeling funds as in claim 7 wherein the step of calculating the predetermined payment based upon a predetermined percentage of a monetary value of the payment to the merchant further comprises transferring the predetermined payment from funds of the credit card issuer.

9. The method of channeling funds as in claim 7 wherein the step of calculating the predetermined payment based upon a predetermined percentage of a monetary value of the payment to the merchant further comprises adding the predetermined payment to funds due from an account holder of the credit card.

10. The method of channeling funds as in claim 1 further comprising generating and transferring periodic summary reports on credit card use from the credit card issuer to the trust organization.

11. The method of channeling funds as in claim 2 further comprising generating and transferring periodic summary reports on credit card use from the credit card issuer to the channeling organization.

12. An apparatus for channeling funds to a plurality of eleemosynary organizations, such apparatus comprising:
means for receiving a payment request by an issuer of a credit card from a merchant based upon use of the credit card where the credit card contains a blind identifier of an eleemosynary organization of the plurality of eleemosynary organizations;
means for transferring a predetermined payment from the issuer to a trust organization along with the blind identifier of the eleemosynary organization;
means for retrieving a name of the eleemosynary organization by the trust organization based upon the transferred blind identifier; and
means for transferring the predetermined payment from the trust organization to the eleemosynary organization based upon the retrieved name of the eleemosynary organization.

13. The apparatus for channeling funds as in claim 12 further comprising means for generating a plurality of credit card applications where each credit card application of the plurality of credit card applications includes the blind identifier of at least one of the plurality of eleemosynary organizations.

14. The apparatus for channeling funds as in claim 13 wherein the means for generating the plurality of credit card applications further comprises means for activating an application generation application provided by a channeling organization for the benefit of the eleemosynary organization.

15. The apparatus for channeling funds as in claim 14 wherein the means for activating the application generation application provided by a channeling organization further comprises means for generating the blind identifier for use on the credit card applications.

16. The apparatus for channeling funds as in claim 15 further comprises means for transferring a name of the eleemosynary organization and generated blind identifier to the trust organization.

17. The apparatus for channeling funds as in claim 13 further comprising means for distributing the generated credit card applications to members or supporters of the at least one of the plurality of eleemosynary organizations.

18. The apparatus for channeling funds as in claim 12 further comprising means for calculating the predetermined payment based upon a predetermined percentage of a monetary value of the payment to the merchant.

19. The apparatus for channeling funds as in claim 18 wherein the means for calculating the predetermined payment based upon a predetermined percentage of a monetary value of the payment to the merchant further comprises means for transferring the predetermined payment from funds of the credit card issuer.

20. The apparatus for channeling funds as in claim 18 wherein the means for calculating the predetermined payment based upon a predetermined percentage of a monetary value of the payment to the merchant further comprises means for adding the predetermined payment to funds due from an account holder of the credit card.

21. The apparatus for channeling funds as in claim 12 further comprising means for generating and transferring periodic summary reports on credit card use from the credit card issuer to the trust organization.

22. The apparatus for channeling funds as in claim 13 further comprising means for generating and transferring periodic summary reports on credit card use from the credit card issuer to the channeling organization.

23. An apparatus for channeling funds to a plurality of eleemosynary organizations, such apparatus comprising:
a partner credit card bank adapted to receive a payment request from a merchant based upon use of a credit card where the credit card contains a blind identifier of an eleemosynary organization of the plurality of eleemosynary organizations;
a contribution processor adapted to calculate and transfer a predetermined payment from the issuer to a trust organization along with the blind identifier of the eleemosynary organization;
a identity processor adapted to retrieve a name of the eleemosynary organization by the trust organization based upon the transferred blind identifier; and
a payment processor adapted to transfer the predetermined payment from the trust organization to the eleemosynary organization based upon the retrieved name of the eleemosynary organization.

24. The apparatus for channeling funds as in claim 23 further comprising an application generator adapted to generate a plurality of credit card applications where each credit card application of the plurality of credit card applications includes the blind identifier of at least one of the plurality of eleemosynary organizations.

25. The apparatus for channeling funds as in claim 24 wherein the application generator further comprises a pseudo-random number generator adapted to generate the blind identifier for use on the credit card applications.

26. The apparatus for channeling funds as in claim 24 further comprising a compact disk adapted to distribute the generated credit card applications to members or supporters of the at least one of the plurality of eleemosynary organizations.

27. A method of channeling funds to a plurality of eleemosynary organizations, such method comprising the steps of:
assigning a blind identifier to each of the plurality of eleemosynary organizations by a channeling organization;
generating a plurality of credit card applications where each credit card application includes the blind identifier of one of the plurality of eleemosynary organizations;
granting a credit card to a credit card applicant by a partner bank based upon completion of one of the plurality of credit card applications by the credit card applicant;
receiving a payment request from a merchant based upon use of the granted credit card by the credit card applicant;
transferring a predetermined payment to a trust organization along with the identifier of the one eleemosynary organization included with the application of the credit card applicant;
retrieving the identity of the eleemosynary organization based upon the blind identifier of the eleemosynary organization; and
transferring the predetermined payment to the eleemosynary organization by the trust organization based upon the retrieved identity of the eleemosynary organization.
